(19) United States
(12) Patent Application Publication
(10) Pub. No.: US 2005/0281476 A1
(43) Pub. Date: Dec. 22, 2005

(54) Examination apparatus

(76) Inventors: Yoshihisa Tanikawa, Chuo-ku (JP); Yoshihiro Kawano, Hachioji-shi (JP); Tadashi Hirata, Hachioji-shi (JP); Kazuhiko Osa, Hachioji-shi (JP)

Correspondence Address: KENYON & KENYON, 1500 K STREET NW, SUITE 700, WASHINGTON, DC, 20005, US

(21) Appl. No.: 11/080,561

(22) Filed: Mar. 16, 2005

(30) Foreign Application Priority Data
Mar. 23, 2004 (JP) 2004-085647
Apr. 8, 2004 (JP) 2004-114715

(51) Int. Cl. G06K 9/40; G06K 9/00; H04N 5/232

(52) U.S. Cl. 382/255; 382/128; 348/349

(57) ABSTRACT

An examination apparatus that can acquire detailed images from a specimen exhibiting dynamic behavior is provided. The examination apparatus comprises an imaging unit that images a specimen exhibiting dynamic behavior; a behavior detecting unit that detects the dynamic behavior of the specimen; an image storing unit that stores the dynamic behavior of the specimen detected by the behavior detecting unit and images of the specimen imaged by the imaging unit so as to be associated with each other; and a still-image extraction unit that extracts an image of the specimen when the specimen is substantially still based on the dynamic behavior of the specimen from the images of the specimen stored in the image storing unit.

### BACKGROUND OF THE INVENTION

1. Field of the Invention

The present invention relates to an examination apparatus for in-vivo examination of living organisms, biological cells, and so forth, by means of a fluorescence probe.

2. Description of Related Art

Recently, visualization of ion concentration, membrane potential, etc. with a fluorescence probe has been carried out using optical microscopes; for example, observation of the biological function of nerve cells and so on, serving as specimens, particularly the observation of dynamic behavior, has been carried out.

A microscope photographing device is known as one such device for examining dynamic behavior (see, for example, Japanese Unexamined Patent Application Publication No. 2000-275539).

However, this type of conventional microscope photographing device takes pictures according to the dynamic behavior of the specimen (acquires still images), and since the shutter is released after a short period of time has passed since the dynamic behavior of the specimen stopped, there is a problem in that the focal position inevitably shifts and the photograph (still image) becomes blurred.

Furthermore, the conventional microscope photographing device described above selectively takes pictures in a still state where the image is in focus, in the dynamic behavior of the specimen, while keeping the focal length of the camera fixed. Therefore, there is a problem in that the acquired images acquired piecemeal, and in particular, it is not possible to examine the appearance of the specimen while it is moving.

### BRIEF SUMMARY OF THE INVENTION

In light of the circumstances described above, it is an object of the present invention to provide an examination apparatus that can acquire detailed images from a specimen (especially part of a living organism in-vivo) exhibiting dynamic behavior. Although the term “specimen” is mainly used to refer to a living organism or part of a living organism in the description of the present embodiment given below, the present invention is not limited thereto.

In order to realize the object described above, the present invention provides the following solutions.

According to a first aspect, the present invention provides an examination apparatus comprising an imaging unit that images a specimen exhibiting dynamic behavior; a behavior detecting unit that detects the dynamic behavior of the specimen; an image storing unit that stores the dynamic behavior of the specimen detected by the behavior detecting unit and images of the specimen imaged by the imaging unit so as to be associated with each other; and a still-image extraction unit that extracts an image of the specimen when the specimen is substantially still based on the dynamic behavior of the specimen from the images of the specimen stored in the image storing unit.

According to this aspect, the image of the specimen acquired by the imaging unit and the dynamic behavior of the specimen detected by the behavior detecting unit are stored in the image storing unit so as to be associated with one another. The images of the specimen include images acquired during dynamic behavior due to a physiological phenomenon such as beating or pulsing of the specimen, or peristalsis, and substantially still images between those images. Information indicating whether the specimen is moving or substantially still includes information on the dynamic behavior of the specimen, which is stored in association with the images. Therefore, by using the information about the dynamic behavior of the specimen as a key to extract only images in which the specimen is substantially still, it is possible to acquire low-blur images of the specimen. In other words, according to the aspect described above, it is possible to image the specimen in-vivo and to acquire low-blur detailed images.

In the aspect described above, the behavior detection unit is preferably an electrocardiograph.

With this configuration, since it is possible to determine the dynamic behavior of the specimen as a periodic waveform using the electrocardiograph, by setting the period and phase thereof, it is possible to more easily select images in which the specimen is substantially still.

In the aspect described above, a scanner that scans light on the specimen is preferable provided, wherein the scanner is configured so as to be controlled based on the dynamic behavior of the specimen.

According to this aspect, the image is acquired by separating it into several blocks. It is thus possible to reduce the image region acquired each time, which allows the scanning region of the scanner to be reduced, and more detailed images to be acquired.

According to a second aspect, the present invention provides an examination apparatus comprising an imaging unit that images an examination site of a specimen exhibiting dynamic behavior; an imaging optical system disposed between the imaging unit and the examination site; a focus adjusting unit that adjusts the focal position of the imaging optical system; a behavior detecting unit that detects the dynamic behavior of the specimen; and a control device that controls the focusing adjusting unit so as to make the focal position coincident with the examination site, based on the dynamic behavior of the specimen detected by the behavior detecting unit.

According to this aspect, the dynamic behavior due to physiological phenomena such as beating or pulsing of the specimen, or peristalsis is detected by operating the behavior detecting unit. When the specimen exhibits dynamic behavior, if the focal position of the objective optical system is kept fixed, the image becomes blurred and the examination position is shifted in the depth direction. However, with the aspect described above, since the control unit controls the focus adjusting unit based on the dynamic behavior of the specimen detected by the behavior detecting unit, it is possible to keep the focal position of the objective optical system coincident with the examination site of the specimen. As a result, it is possible to acquire detailed images during operation, as well as when the specimen is substantially still.

In the aspect described above, the behavior detecting unit may be a sensor that detects the surface position of the specimen. By detecting the surface position using the sensor, it is possible to directly obtain the amount of displacement due to the dynamic behavior of the specimen. Therefore, complex calculations to control the focus position of the objective optical system are not required, and therefore, it is possible to comply with the dynamic behavior of the specimen without delaying the focal position of the objective optical system.

In the aspect described above, the focus adjusting unit preferably includes a variable-focus lens whose focal length is varied based on a control signal from the control device. With the variable focus lens, it is possible to ensure sufficient adjustment speed of the focal position of the objective optical system with a simple configuration.

In the aspect described above, the focus adjusting unit may be formed of a linear actuator that moves the focal position of the imaging optical system based on a control signal from the control device.

In the aspect described above, a stage on which the specimen is mounted may be provided, wherein the focus adjusting unit is formed of a linear actuator that displaces the stage based on a control signal from the control device.

A high-speed actuator, such as a piezo motor or a voice-coil motor, is used as the linear actuator, and it is thus possible to ensure a sufficient adjustment speed of the focus position of the objective optical system with a simple configuration.

In the aspect described above, the control device controls the focus adjusting unit so as to maintain the focal point of the imaging optical system at a position in the depth direction shifted by a predetermined distance from the surface position of the specimen detected by the sensor.

In the case where the examination site is below the surface, by controlling the focus adjusting unit to maintain the focal position at a position shifted by a predetermined distance in the depth direction from the position detected by the sensor, focus is maintained on the shifted examination site by following the fluctuations of the specimen surface, which allows images to be acquired.

In the aspect described above, the control device may include a history recording unit that records the history of the dynamic behavior of the specimen detected by the behavior detecting unit and a behavior estimating unit that estimates the dynamic behavior of the specimen based on the history recorded in the history recording unit, and the control device controls the focus adjusting unit based on the estimated dynamic behavior.

For example, in the case where vibrations occur at predetermined intervals, such as a pulse, by estimating based on the history stored in the history storage unit, the focus position of the objective optical system can follow the examination site more rapidly, and more detailed images can thus be acquired.

According to the present invention, it is possible to provide an examination apparatus that can acquire detailed images from a specimen exhibiting dynamic behavior.

Furthermore, according to the present invention, when carrying out in-vivo examination of a specimen exhibiting dynamic behavior, imaging while making the focal position follow the dynamic behavior of the specimen, which allows examination results including more information to be obtained.

The examination apparatus of the present invention is suitable for use as a biological examination apparatus. Also, the examination apparatus of the present invention is suitable for use as a microscope image-acquiring apparatus.

### BRIEF DESCRIPTION OF THE SEVERAL VIEWS OF THE DRAWINGS

FIG. 1 is a schematic structural diagram showing an examination apparatus according to a first embodiment of the present invention.

FIG. 2 shows waveform data obtained by a behavior detecting unit.

FIG. 3 is a schematic structural diagram of an examination apparatus according to a second embodiment of the present invention.

FIG. 4 is a schematic structural diagram of an examination apparatus according to a third embodiment of the present invention.

FIG. 5 is a schematic structural diagram of an examination apparatus according to a fourth embodiment of the present invention.

FIG. 6 is a schematic structural diagram of an examination apparatus according to a fifth embodiment of the present invention.

FIG. 7 is a schematic structural diagram of an examination apparatus according to a sixth embodiment of the present invention.

FIG. 8 is a schematic structural diagram of an examination apparatus according to a seventh embodiment of the present invention.

FIG. 9 is a schematic structural diagram of an examination apparatus according to an eighth embodiment of the present invention.

FIG. 10 is a diagram for explaining an example the motion of a scanner.

FIG. 11 is a diagram for explaining FIG. 10, showing waveform data obtained by a behavior detecting unit, similar to FIG. 2.

FIG. 12 is a diagram showing the overall configuration of the examination apparatus according to the ninth embodiment of the present invention.

FIGS. 13A and 13 are diagrams for explaining focus adjustment of the examination apparatus shown in FIG. 12.

FIG. 14 shows the overall configuration of a modification of the examination apparatus in FIG. 12.

FIG. 15 shows the overall configuration of another modification of the examination apparatus in FIG. 12.

FIG. 16 shows the overall configuration of an examination apparatus according to a tenth embodiment of the present invention.

FIG. 17 is a block diagram showing a control device of an examination apparatus according to an eleventh embodiment of the present invention.

FIG. 18 is a graph showing the dynamic behavior history of a specimen produced in the control device in FIG. 16.

### DETAILED DESCRIPTION OF THE INVENTION

### First Embodiment

An examination apparatus according to a first embodiment of the present invention will be described below with reference to the attached drawings.

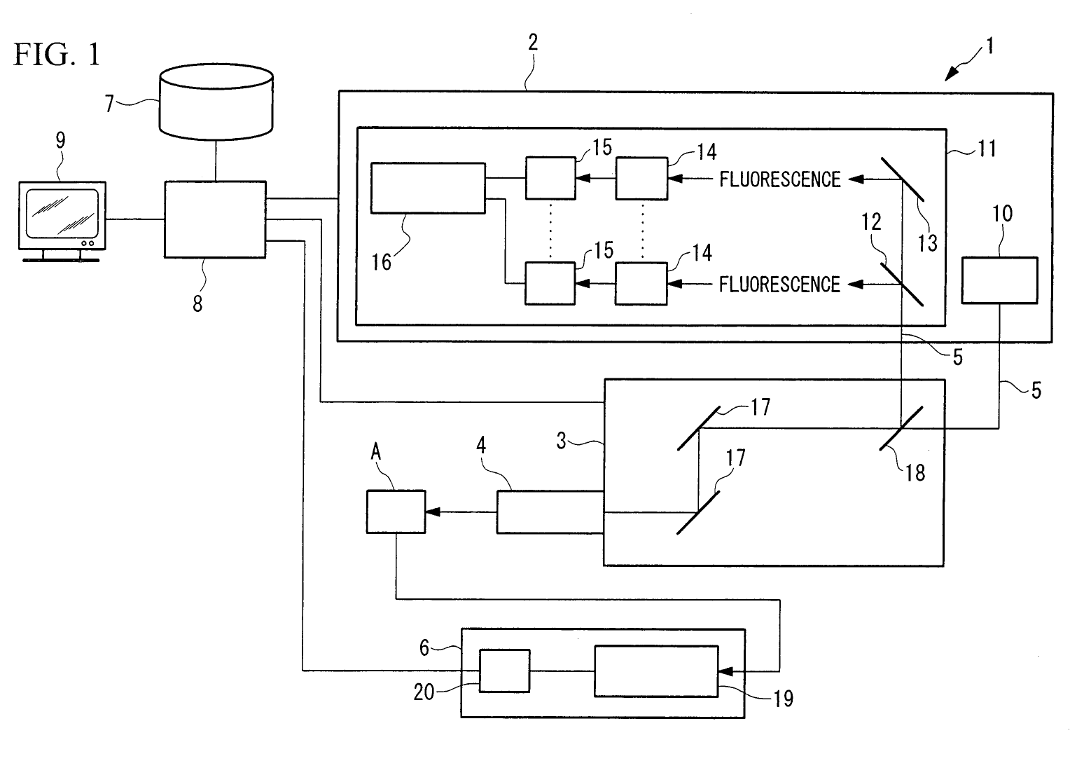

As shown in FIG. 1, an examination apparatus 1 according to this embodiment includes, as main components, an optical unit 2, a scanning unit 3, an objective optical system 4 that is attached to the scanning unit 3, optical-fibers 5 that connect the optical unit 2 and the scanning unit 3, a behavior detecting unit 6, an image storing unit 7, a control device (a still image extraction unit) 8, and a display 9.

The optical unit 2 includes a laser light source unit 10 and a detection optical system 11.

The laser light source unit 10 includes a laser light source formed of a semiconductor laser, a collimator optical system formed of a lens and a pinhole, and a dichroic mirror.

The detection optical system 11 includes a dichroic mirror 12, a mirror 13, photomultiplier tubes (imaging units) 14, analog-to-digital converters (AD) 15, a controller 16, barrier filters, lenses, and confocal pinholes.

The scanning unit 3 includes a collimator optical system for substantially collimating excitation light from the optical fibers 5, an optical scanning unit for scanning the excitation light from the collimator optical system onto a specimen A, and a pupil projection optical system for imaging the excitation light from the optical scanning unit at an intermediate image position.

The collimator optical system includes a position adjusting mechanism that can move the collimator lens constituting the collimator optical system in the optical axis direction.

The optical scanning unit includes a pair of galvano mirrors (scanners) 17 that can oscillate about orthogonal axes, which enables the collimated light emitted from the collimator optical system to be scanned two-dimensionally.

A dichroic mirror 18 is provided in the scanning unit 3. This dichroic mirror guides excitation light from the laser light source unit 10 to the specimen A and also guides fluorescence from the specimen A to the photomultiplier tubes 14 in the detection optical system 11.

The objective optical system 4 is designed to re-image the intermediate image of the excitation light imaged by the pupil projection optical system onto the specimen A. In addition, it is also has a configuration such that the focal point is conjugated near the center of the two galvano mirrors 17 constituting the optical scanning unit, by means of the pupil projection optical system.

The optical fiber 5 carries excitation light emitted from the laser light source unit 10 described above and also guides fluorescence emitted from the specimen A to the detection optical system 11.

With this configuration, the fluorescence emitted by the specimen A passes through the objective optical system 4, the pupil projection optical system, the optical scanning unit, the collimator optical system, and the optical fiber 5, and thereafter, is detected by the photomultiplier tubes 14 of the detection optical system 10 in the optical unit 2.

Images of the specimen A detected by the photomultiplier tubes 14 are converted to digital signals by the analog-to-digital converters 15 and are output to the image storing unit 7 via the controller 16 and the control device 8.

The behavior detecting unit 6 includes a pulse detector 19 for detecting the dynamic behavior (a pulse in a blood vessel in the present embodiment) of the specimen A and an analog-to-digital converted (AD) 20.

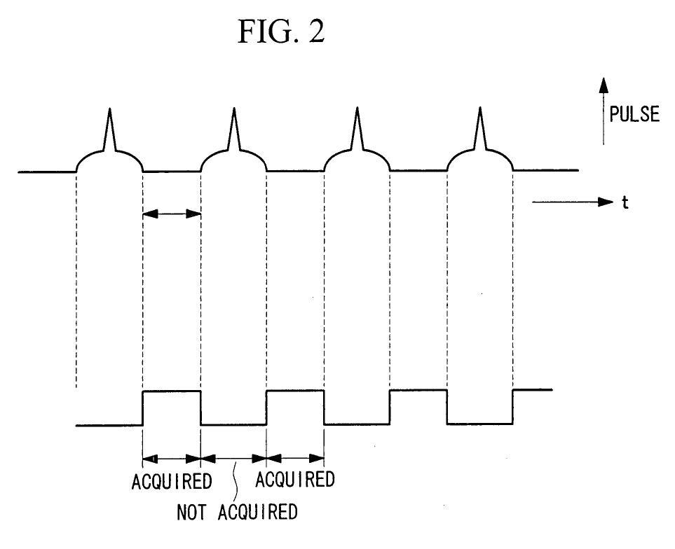

After being detected as waveform data such as that shown in FIG. 2 by the pulse detector 19, the behavior of the specimen A is converted to a digital signal by the analog-to-digital converter 20 and is output to the image storing unit 7 via the control device 8.

The image storing unit 7 associates the image data transmitted from the analog-to-digital converters 15 and the behavior data transmitted from the analog-to-digital converter 20 and then stores the data.

Among the data stored in the image storing unit 7, the control device 8 extracts image data for a part that does not pulse, that is, data for the portion shown by the flat part at the top of FIG. 2 (the part indicated by “acquired” at the bottom of FIG. 2) (in other words an image of the specimen A in a substantially still state). In addition, the control device 8 outputs the extracted image data to the display 9.

Furthermore, the control device 8 carries out wavelength control of the laser light source; wavelength selection of the dichroic mirrors, filters, and the like; control of a wavelength separating device; analysis and display of the detected information received by the photomultiplier tubes 14 of the detection optical system 11; driving control of the optical scanning unit, and so on.

With this configuration, it is possible to display images of when there is no motion of the specimen A, that is to say, detailed, in-focus images (images in a substantially still state), on the screen of the display 9.

### Second Embodiment

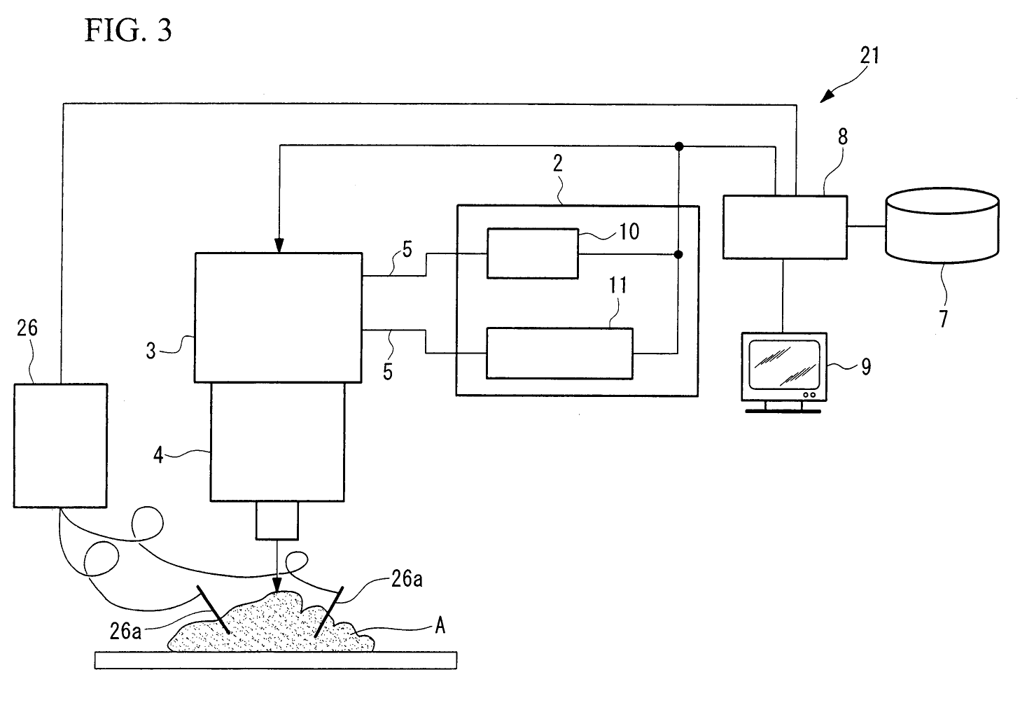

A second embodiment of the examination apparatus according to the present invention will now be described using FIG. 3.

An examination apparatus 21 in this embodiment differs from that in the first embodiment described above in that a heart monitor (electrocardiograph) 26 functioning as a behavior detecting unit is provided. The other structural elements are the same as in the embodiment described above, and therefore, a description of those elements is omitted here.

Also, the same parts as in the first embodiment described above are assigned the same reference numerals.

The heart monitor 26 records temporal variations in the action potential of the heart of the specimen A and obtains waveform data like that shown in FIG. 2 via electrodes 26a attached to the surface of the specimen A as a potential variation in which the action current due to myocardial action is spatially and temporally combined.

Since the waveform data obtained by the heart monitor 26 in this way (that is, an electrocardiogram) is displayed as a periodic waveform, it is possible to more easily select images in the substantially still state by setting the period and phase thereof.

The other advantages are the same as in the first embodiment described above, and a description thereof is thus omitted.

### Third Embodiment

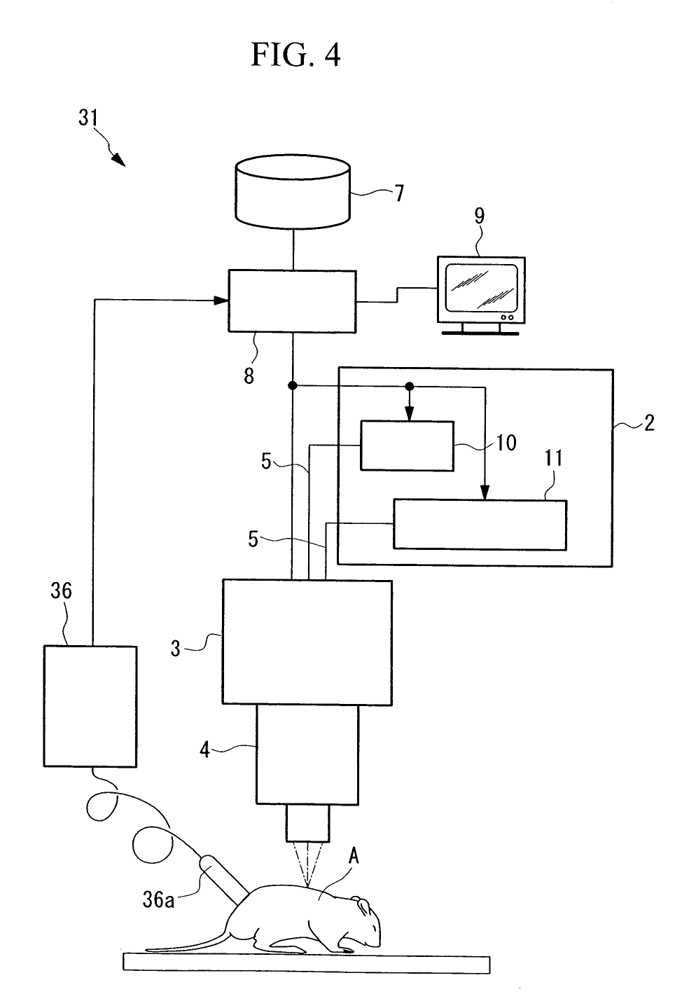

A third embodiment of an examination apparatus according to the present invention will now be described using FIG. 4.

An examination apparatus 31 of this embodiment differs from that in the first embodiment described above in that an ultrasonic detector 36 serving as a behavior detecting unit is provided. The other structural elements are the same as those in the embodiments described above, and therefore, a description of those elements shall be omitted here.

Also, the same parts as in the above-described embodiments are assigned the same reference numerals.

The ultrasonic detector 36 acquires information on the tissue structure inside the specimen by means of pulses of ultrasonic waves with medical diagnostic equipment using ultrasound. In this embodiment, the blood flow in the specimen A is measured via an ultrasonic sensor 36a, and the blood flow is detected as the pulse in the blood vessels.

With this configuration, similar to the embodiments described above, it is possible to acquire waveform data like that shown in FIG. 2.

Since the ultrasonic detector 36 uses ultrasonic waves, it is possible to reliably acquire waveform data by means of a pulse with little damaging effect on the specimen A.

The other advantages are the same as in the first embodiment described above, and a description thereof is thus omitted here.

### Fourth Embodiment

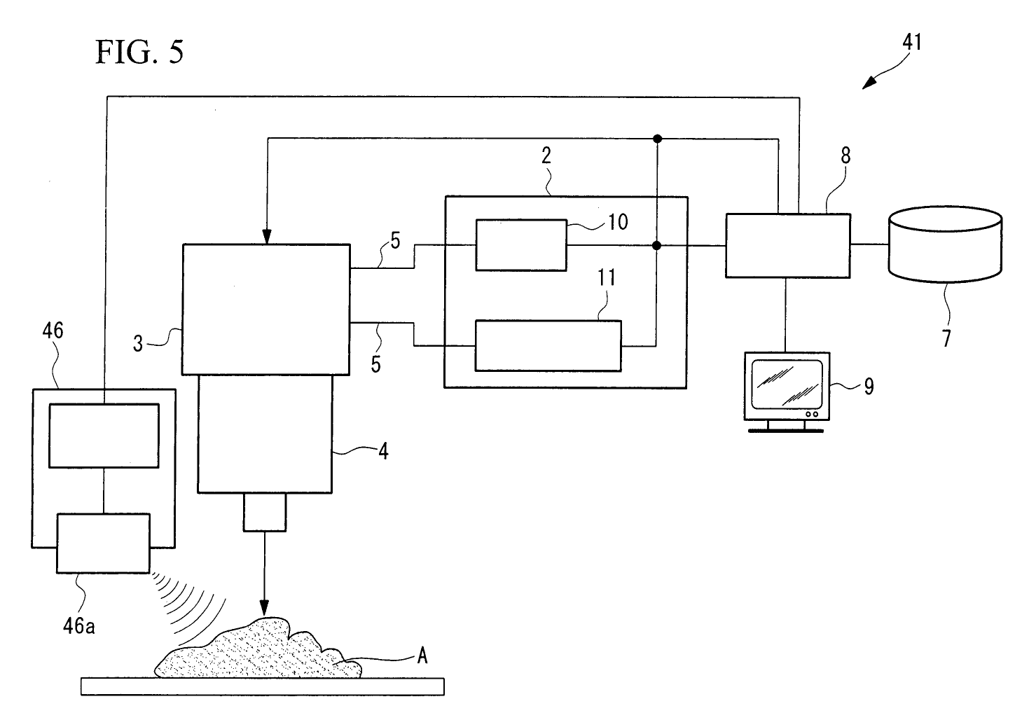

A fourth embodiment of the examination apparatus according to the present invention will now be described using FIG. 5.

The examination apparatus 41 in this embodiment differs from that in the first embodiment described above in that an acoustic detector 46 is provided as the behavior detecting unit. The other structural elements are the same as those in the embodiments described above, and therefore, a description of those elements shall be omitted here.

Also, the same parts as in the embodiments described above are assigned the same reference numerals.

The acoustic detector 46 detects the behavior of the specimen A in the form of acoustic waves. In this embodiment, the sound of the pulse produced from the specimen A (or the cardiac sound) is measured via an acoustic sensor (electret condenser mike: ECM) 46a, and this sound is detected as the pulse.

With this configuration, similar to the embodiments described above, it is possible to acquire waveform data like that shown in FIG. 2.

It is not necessary for the acoustic sensor 46a detecting the sound produced from the specimen A to be attached to the surface of the specimen A, like the electrode 26a and the ultrasonic sensor 36a described above, nor is it necessary to make contact via a contact gel therebetween. Therefore, it is possible to more easily acquire waveform data due to the pulse.

The other advantages are the same as in the first embodiment described above, and a description thereof is thus omitted here.

### Fifth Embodiment

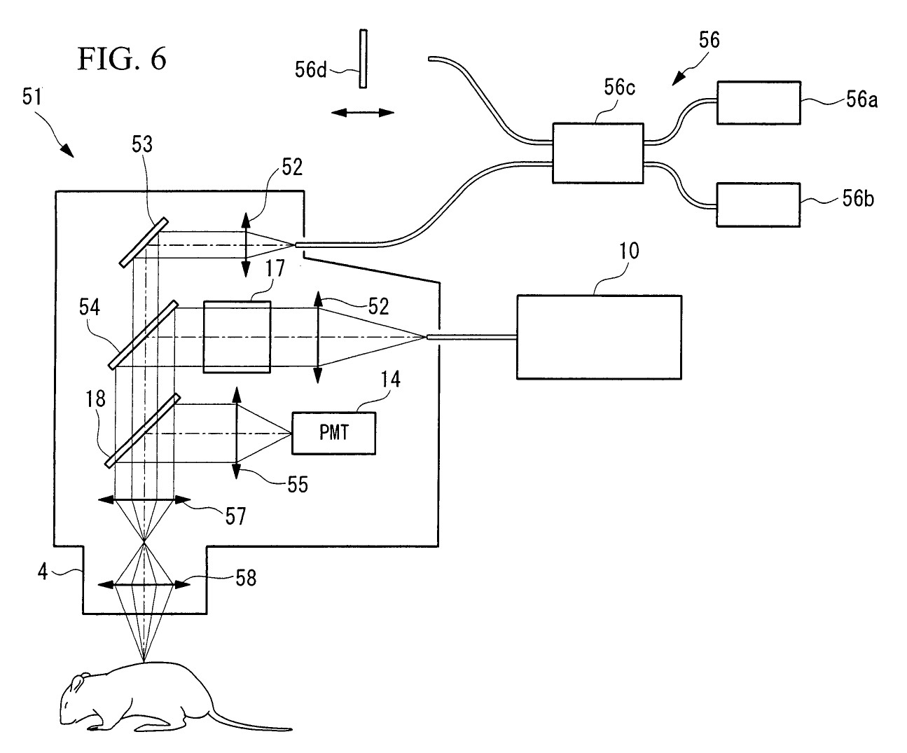

A fifth embodiment of the examination apparatus according to the present invention will now be described using FIG. 6.

An examination apparatus 51 in this embodiment differs from that in the first embodiment described above in that an optical coherence tomograph 56 is provided as the behavior detecting unit. The other structural elements are the same as in the embodiments described above, and therefore, a description of those elements is omitted here.

The same parts as in the embodiments described above are assigned the same reference numerals. In addition, reference numerals 52, 53, 54, 55, 57, and 58 in the figure represent a collimator lens, a mirror, a half-mirror, a lens, a pupil projection lens, and an objective lens, respectively.

The optical coherence tomography (hereinafter referred to as OCT) 56 is formed of an optical detector 56a, a low-coherence light source 56b, a fiber coupler 56c, and a mirror 56d, serving as main elements thereof.

The light output from the low-coherence light source 56b (low coherence light having a low level of coherence), is divided into two beams at the fiber coupler 56c, and these beams are directed towards the mirror 56d and the specimen A, respectively. At this point, reflection light from various positions is contained in reflection light returning from the specimen A, such as light reflected at the surface of the specimen A, light reflected from a shallow position inside the object, or light reflected from deep inside the object. However, since the incident light has low coherence, the reflected light in which interference is observed is only the light reflected from a reflecting surface whose distance from the fiber coupler is at a position L±Δ½, where the distance from the fiber coupler 56c to the mirror 56d is L and the coherence length is ΔL. Therefore, if the distance from the fiber coupler 56c to the mirror changes, only the reflected light from the reflecting surface inside the specimen A corresponding to this distance can be selectively output, and it is thus possible to obtain reflectance at any position inside the specimen A. By imaging the thus obtained reflectance distribution, it is possible to visualize the structural information of the interior of the specimen A.

Even if such structural information disappears, it is possible to obtain waveform data like that shown in FIG. 2, similarly to the embodiments described above.

Since the OCT 56 uses near-infrared light, it is possible to reliably acquire waveform data by means of a pulse with little damaging effect on the specimen A. In addition, the OCT 56 has micrometer-order resolution, is low cost, and has superior miniaturization ability.

When such an OCT 56 is used, similarly to the acoustic detector 46 described in the fourth embodiment, there is no need to attach anything to the surface of the specimen A, like the electrodes 26a or the ultrasonic sensor 36a described above, and there is no need to make contact via a contact gel. Therefore, it is possible to easily acquire waveform data due to a pulse.

Also, since it is possible to make the optical axis of the low-coherence light source 56b and the optical axis of the laser light source 10 coaxial, the apparatus can be made more compact.

The other advantages are the same as in the first embodiment described above, and a description thereof is thus omitted here.

### Sixth Embodiment

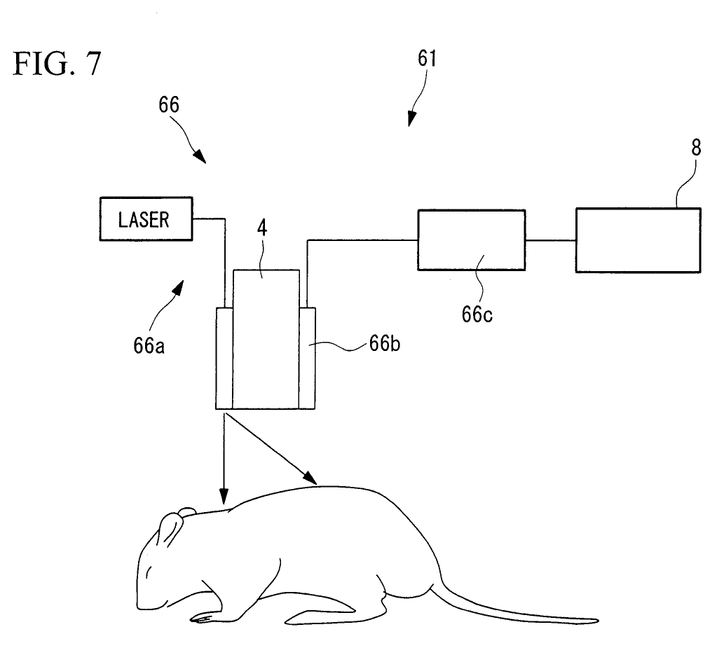

A sixth embodiment of the examination apparatus according to the present invention will now be described using FIG. 7.

An examination apparatus 61 in this embodiment differs from that in the first embodiment described above in that an out-of-plane displacement measuring device 66 using a speckle pattern is provided as the behavior detecting unit. The other structural elements are the same as those in the embodiments described above, and therefore, a description of those elements is omitted here.

Also, the same parts as in the embodiments described above are assigned the same reference numerals.

The out-of-place displacement measuring device 66 includes a laser irradiation unit 66a that irradiates the surface of the specimen A with laser light; a camera 66b that captures a speckle pattern produced by scattering and reflection at the surface of the specimen A as an image; and a processing device 66c that detects the image captured by the camera 66b, that is, the degree of pulsing from the amount of movement of the speckle pattern, and that converts it to waveform data due to the pulse.

By doing so, it is possible to acquire waveform data like that shown in FIG. 2, similarly to the embodiments described above.

When such an out-of-place displacement measuring device 66 using a speckle pattern is used, similarly to the acoustic detector 46 described in the fourth embodiment, there is no need to attach anything to the surface of the specimen A, like the electrodes 26a or the ultrasonic sensor 36a described above, and there is no need to make contact via a contact gel. Therefore, it is possible to easily acquire waveform data due to a pulse.

Since the reflected laser light produced from the laser irradiation unit 66a is acquired, it is possible to acquire waveform data having low noise and higher accuracy.

The other advantages are the same as in the first embodiment described above, and a description thereof is thus omitted here.

### Seventh Embodiment

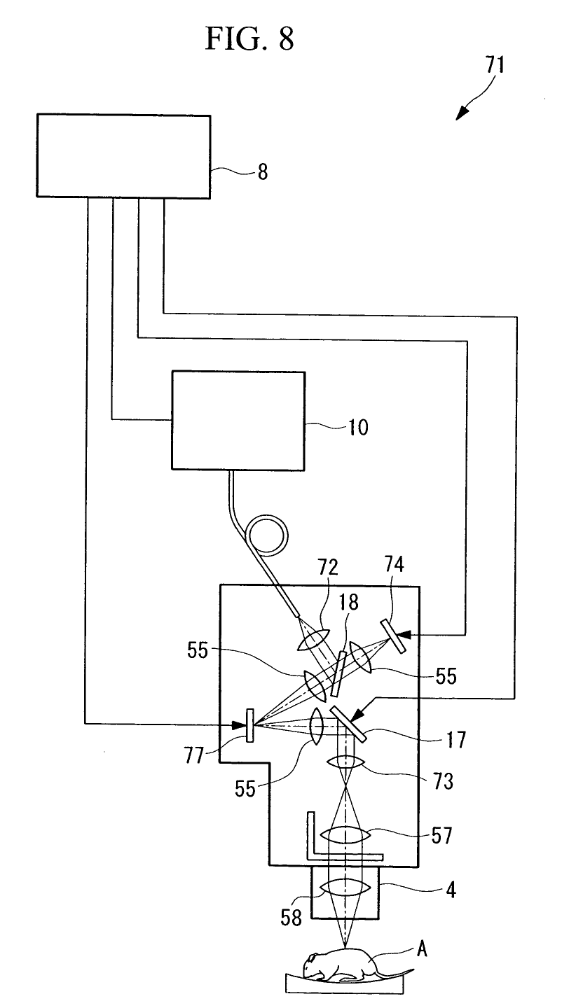

A seventh embodiment of the examination apparatus according to the present invention will now be described using FIG. 8.

An examination apparatus 71 in this embodiment differs from that in the first embodiment described above in that, instead of the pair of galvano mirrors 17 that can oscillate about orthogonal axes, one digital micro-mirror device (hereinafter referred to as DMD) 77 and one galvano mirror 17 are provided, and in addition, instead of the photomultiplier tubes 14, a CCD (Charge Coupled Devices) 74 is provided. The other structural elements are the same as those in the embodiments described above, and therefore, a description of those elements shall be omitted here.

The same parts as in the embodiments described above are assigned the same reference numerals. Also, reference numerals 72 and 73 in the figure represent a cylindrical lens and an imaging lens, respectively.

The DMD (scanner) 77 includes a plurality of minute mirrors arranged in a line and thus emits incident light in the form of a line.

The CCDs 74 converts an optical (image) signal into an electrical signal using semiconductor elements (photodiodes) whose capacitance changes in response to the input light (photons).

The DMD 77, the CCDs 74, and the galvano mirror 17 are controlled by the control device 8 to drive them, and so on.

By using the DMD 77 in the optical scanning unit in this way, it is possible to acquire images of the specimen A at high speed, and it is also possible to acquire brighter images.

### Eighth Embodiment

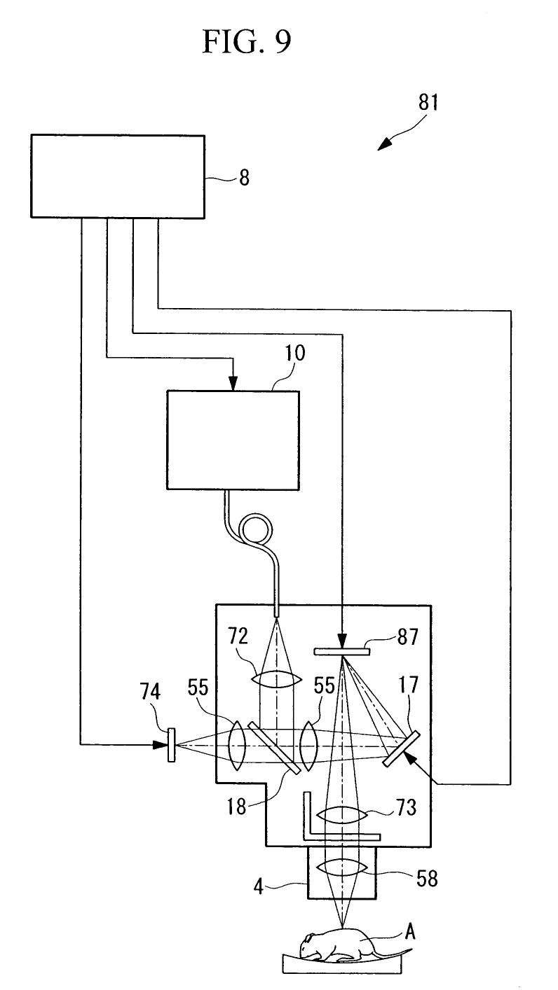

An eighth embodiment of an examination apparatus according to the present invention will now be described using FIG. 9.

An examination apparatus 81 of this embodiment differs from that in the seventh embodiment described above in that a DMD 87 used as both a scanner and as a confocal pinhole is provided. The other structural elements are the same as in the embodiments described above, and therefore, a description of those elements shall be omitted here.

Also, the same parts as in the embodiments described above are assigned the same reference numerals.

By providing the DMD 87 that is used as a scanner and as a confocal pinhole in this way, it is possible to acquire a confocal image of the specimen A at high speed, and it is also possible to acquire brighter images.

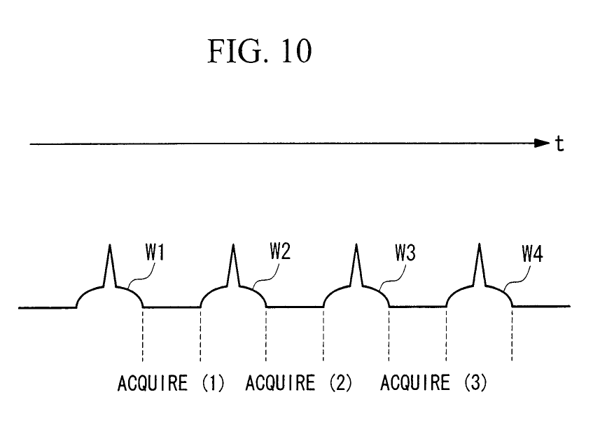

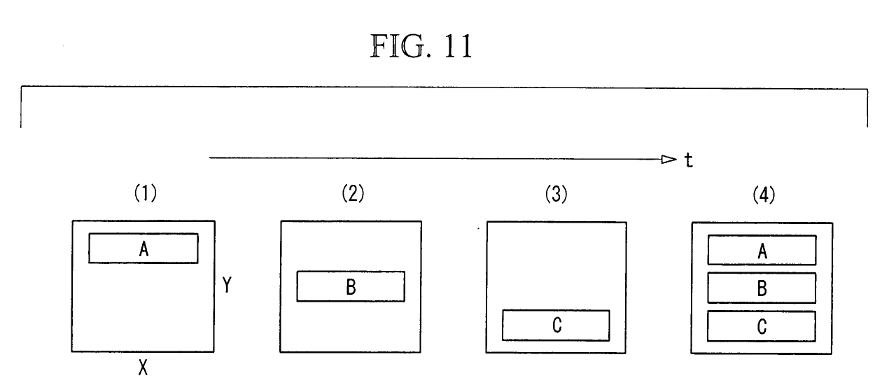

In the embodiment described above, it is possible to control the scanner as shown in FIG. 11, for example, at each section shown in FIG. 10.

More specifically, between a first waveform W1 shown in FIG. 10 and a second waveform W2 subsequent thereto, an image A indicated by (1) in FIG. 11 is acquired, between the second waveform W2 and a third waveform W3 subsequent thereto, an image B indicated by (2) in FIG. 11 is acquired, and between the third waveform W3 and a fourth waveform W4 subsequent thereto, an image C indicated by (3) in FIG. 11 is acquired, and finally, a single image indicated by (4) in FIG. 11 can be displayed on the display 9.

In other words, a single image is split into several blocks and acquired, and then these images are finally combined so that a single image can be acquired.

By doing so, more detailed images can be acquired because the image region acquired each time is reduced, resulting in a smaller scanning range of the scanner.

Also, when the image region that can be acquired during one period when the specimen is substantially still is reduced because of the fast dynamic behavior, the operating range of the scanner is restricted, and only an image in a smaller region may be acquired.

The invention is not limited to the configuration described in the above embodiments; for instance, a laser range finder can be used as the behavior detecting unit.

In addition, any type of device may be used as the behavior detecting unit so long as it is capable of detecting the dynamic behavior of the specimen A, that is, pulsing of blood vessels, motion of the lungs due to breathing, peristalsis of the stomach, beating of the heart, and so on. Various modifications are possible.

### Ninth Embodiment

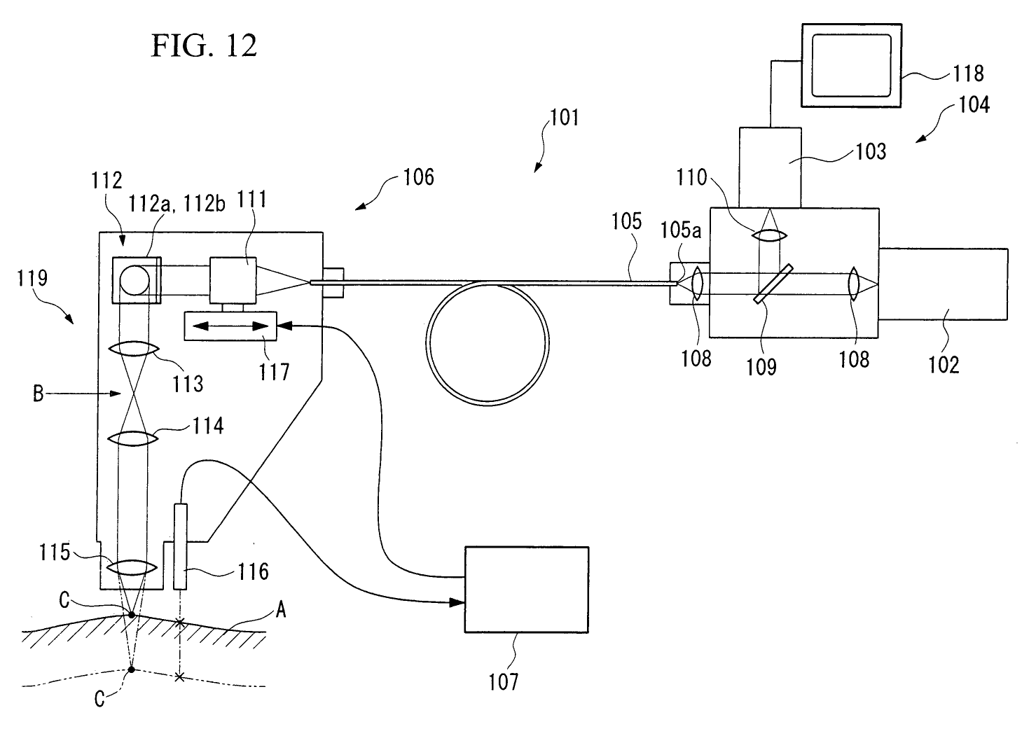

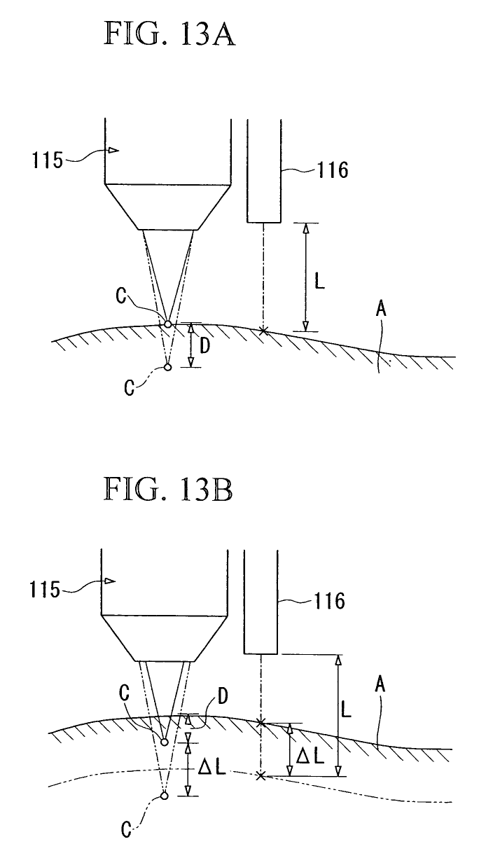

An examination apparatus according to a ninth embodiment of the present invention will be described below with reference to FIG. 12 and FIGS. 13A and 13B.

As shown in FIG. 12, an examination apparatus 101 according to this embodiment includes an optical unit 104 formed of a laser light source 102 and photodetector (imaging unit) 103; an optical fiber 105 that transmits laser light from the laser light source 102 and fluorescence to the photodetector 103; a measurement head 106 that scans laser light transmitted by the optical fiber 105 onto a specimen A, such as a small experimental animal, and that receives fluorescence emitted from the specimen A and guides it to the optical fiber 105; and a control device 107 that controls the focal position of the measurement head 106.

Collimator lenses 108 and a dichroic mirror 109 are provided in the optical unit 104. The laser light emitted from the laser light source 102 is first collimated by the collimator lens 108, and then it is transmitted through the dichroic mirror 109 and is focused again at a tip 105a of the optical fiber 105 by the collimator lens 108. On the other hand, fluorescence emitted from the tip 105a of the optical fiber 105 is reflected by the dichroic mirror 109, and is focused onto the photodetector 103 by a focusing lens 110 to be detected thereat.

The measurement head 106 includes a collimator optical system 111 that converts the laser beam transmitted by the optical fiber 105 into a collimated beam; an optical scanning unit 112 that deflects the collimated beam and scans it two-dimensionally; a pupil projection optical system 113 that images the light from the optical scanning unit 112 at an intermediate image position B; an imaging optical system 114 that converts the light forming the intermediate image back into a collimated beam; an objective optical system 115 that re-images the intermediate image at an examination site of the specimen A; and a distance sensor 116 that measures the distance between the measurement head 106 and the surface of the specimen A. A linear actuator 117 that moves some or all of the lenses constituting the collimator optical system 111 in the optical axis direction is provided in the collimator optical system 111. The optical scanning unit 112 includes, for example, two galvano mirrors 112a and 112b that can rotate about two mutually orthogonal rotation axes.

The linear actuator 117 is formed of a piezo motor, for example.

The photodetector 103 is, for example, a photomultiplier tube.

The photodetector 103 is connected to a monitor 118 so as to display the acquired fluorescence images.

The control device 107 receives a detection signal from the distance sensor 116 and calculates the distance between the measurement head 106 and the surface of the specimen A in real time. The control device 107 also outputs to the linear actuator 117 displacement commands for the linear actuator 117.

The control device 107 is provided with an offset function for offsetting by a predetermined distance a focal position C of an imaging optical system 119, which includes the elements from the collimator optical system 111 to the objective optical system 115.

The operation of the examination apparatus 101 according to this embodiment, having such a configuration, will be described below.

The laser light emitted from the laser light source 102 is transmitted in the optical fiber 105 and enters the measurement head 106, and after being converted to collimated light by the collimator optical system 111, it is deflected by the optical scanning unit 112 and is imaged at the specimen A via the pupil projection optical system 113, the imaging optical system 114, and the objective optical system 115, where it produces fluorescence. The fluorescence produced in the specimen A passes through the objective optical system 115, the imaging optical system 114, the pupil projection optical system 113, the optical scanning unit 112, and the collimator optical system 111, returns to the optical unit 104 through the fiber 105, is split off from the optical axis towards the laser light source 2 by the dichroic mirror 109 to be detected at the photodetector 3, and is displayed on the monitor 118.

In this case, to start examination of the specimen A, such as a small experimental animal, first the laser light is irradiated onto the specimen A, and light reflected at the surface of the specimen A is detected and displayed on the monitor 118. The operator operates the apparatus while viewing the monitor 118 to bring the focal position C of the objective optical system 119 into coincidence with the surface of the specimen A. Since the surface of the specimen A is pulsing, the focal position C may be brought into coincidence with the surface of the specimen A when the pulsing has substantially stopped. Then, control by the control device 107 starts when the focal position C is made coincident with surface of the specimen A.

Since the distance sensor 116 measures the distance between the measurement head 106 and the surface of the specimen A, the control device 107 can acquire a displacement ΔL of the surface of the specimen A due to the pulsing with reference to the distance L between the measurement head 106 (in this embodiment, the surface at the tip of the distance sensor fixed to the measurement head 106) and the surface of the specimen A under the condition where the focal position C is coincident with the surface of the specimen A. Then, by moving the linear actuator 117 by this ΔL such that the collimator optical system 111 is moved so as to shift the focal position C in the same direction as the displacement direction of the surface of the specimen A, it is possible to maintain the coincidence between the focal position C and the surface of the specimen A. In particular, in the examination apparatus 101 according to this embodiment, since a high-speed piezo motor is used as the linear actuator 117, it is possible to make the focal position track the surface of the specimen A rapidly and accurately, regardless of variations due to pulsing.

In practice, since the examination site is located at a position at a predetermined depth D in the depth direction from the surface of the specimen A, the collimator optical system 111 is moved using the offset function and thus shifts the focal position by D, as shown by the broken line in FIG. 13A. By doing so, when the displacement of the surface of the specimen A by ΔL due to the pulsing of the specimen A is calculated in the control device 107, as shown in FIG. 13B, the focal position C is also displaced by ΔL by operating the linear actuator 117, and therefore, the focal position C is maintained at a position a distance D below the surface of the specimen A.

In other words, with the examination apparatus 101 according to this embodiment, the dynamic behavior of the specimen A is detected by the distance sensor 116 to adjust the focal position C of the objective optical system 119 in real time so that it is coincident with the examination site disposed at a position a distance D below the surface of the specimen A. As a result, it is possible to acquire low-blur detailed images. Also, since it is possible to acquire images of a specimen A exhibiting dynamic behavior while moving as well as when the specimen A is substantially still, the information obtained from the specimen A can be acquired efficiently.

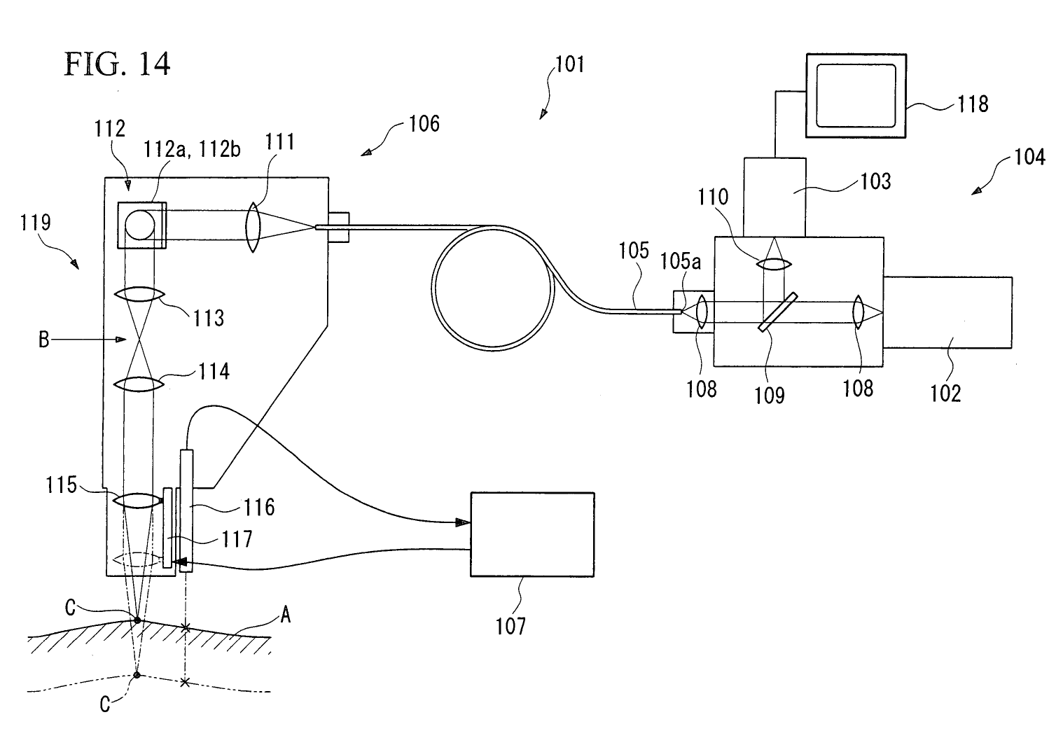

In the examination apparatus 101 according to this embodiment, a piezo motor is used as the linear actuator 117 for moving the collimator optical system 111; however, any other high-speed linear actuator, such as a voice coil motor, may be used instead. Also, the focal position C is adjusted by means of the collimator optical system 111; however, as shown in FIG. 14, the focal position C may instead by adjusted by moving the objective optical system 115 using the linear actuator 117. Moreover, the tip of the optical fiber 105 may be moved in the optical axis direction by the linear actuator 117.

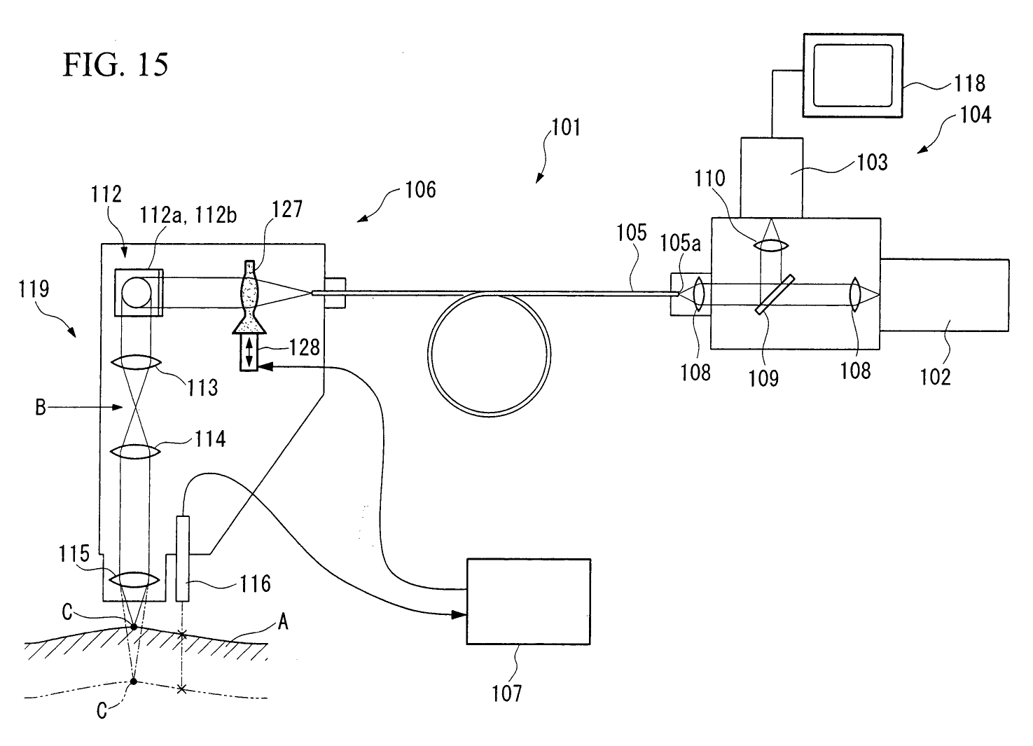

In addition, instead of the method whereby the collimator optical system 111 or the objective optical system 115 is moved by the linear actuator 117, as shown in FIG. 15, in some of the lenses constituting the collimator optical system 111 or the objective optical system 115, a variable focus lens 127 that varies the focal position C by changing the pressure of a liquid filled inside the lens body to change the surface shape of the lens body may be employed. In this case, the focal position C may be changed by providing a linear actuator like a piezo element connected to the variable focus lens 127, and by controlling the pressure in the variable focus lens 127 by means of motion commands from the control device 107.

In the case where a reflection-type objective optical system is employed, a variable focus mirror (not shown in the drawings) may be used. Although an example wherein the distance sensor 116 is disposed outside the objective optical system 115 has been described, it may also be provided inside the same housing as the objective optical system 115.

Furthermore, although the apparatus is focused using an eyepiece when commencing examination, automatic focusing may be carried out, for example, by computing the contrast of the detected images and shifting the linear actuator to a position where the contrast is maximized.

Although the distance sensor 116 is used to detect the dynamic behavior of the specimen A, another pulse detecting unit may be used instead, such as, for example, a heart monitor, an ultrasonic detector, an acoustic sensor (an electret condenser mike: ECM), an optical coherence tomography (OCT), an out-of-plane displacement measuring device using a speckle pattern, and so forth.

### Tenth Embodiment

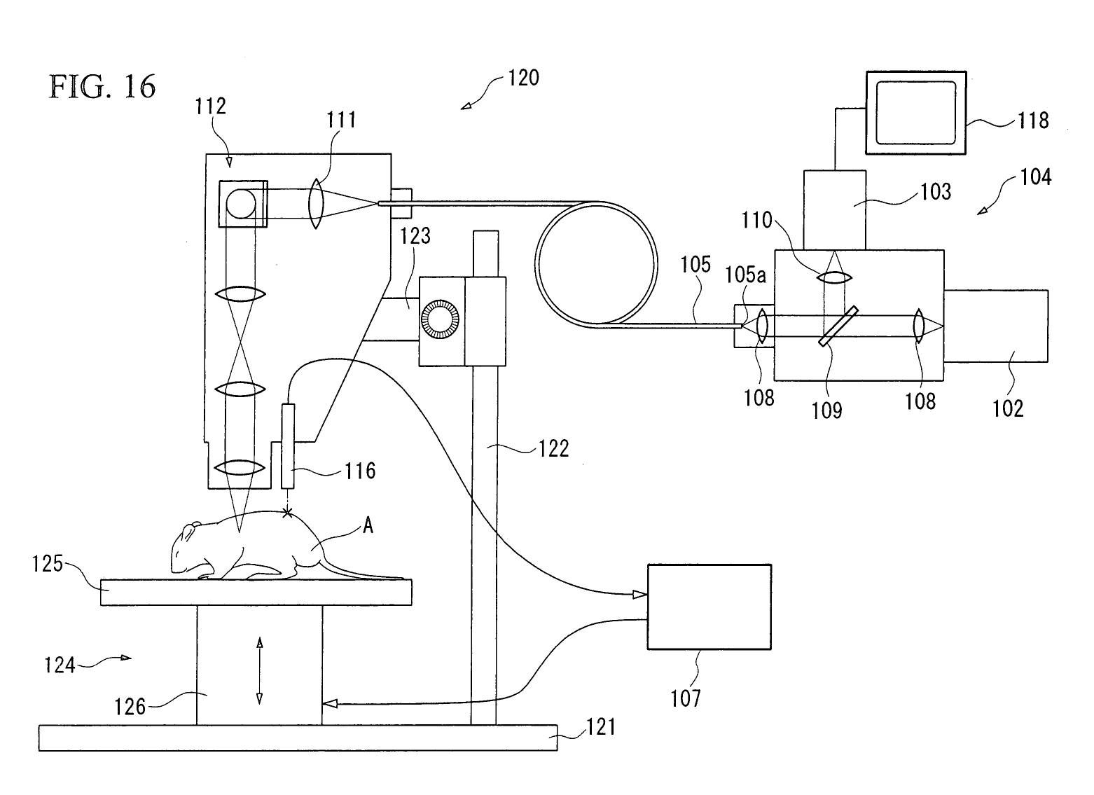

Next, an examination apparatus according to a tenth embodiment of the present invention will be described with reference to FIG. 16.

In the description of this embodiment, parts that are in common with the structure of the examination apparatus 101 according to the ninth embodiment described above are assigned the same reference numerals, and the description thereof shall be simplified.

An examination apparatus 120 according to this embodiment includes a base 121 disposed horizontally, a support stand 122 extending vertically from the base 121, an arm 123 that is attached to the support stand 122 and that supports the measurement head 106 described above, and a stage 124 that is fixed to the base 121 and on which the specimen A is mounted. The stage 124 includes an XY table 125 that moves the specimen A in the two horizontal directions and a raising and lowering mechanism 126 that moves the XY table 125 upwards and downwards. The measurement head 106 is disposed above the stage 124, with a certain distance therebetween, and its optical axis is directed vertically downward.

The examination apparatus 120 according to this embodiment differs from the examination apparatus 101 according to the ninth embodiment in that a focus adjusting unit is formed by the raising and lowering mechanism 126 of the stage 124, rather than providing a focus adjusting unit at the measurement head 106 side.

The control device 107 receives information from the distance sensor 116 provided in the measurement head 6 and outputs commands for moving the raising and lowering mechanism 126 upwards and downwards so that the output variation from the distance sensor 116 becomes zero.

With the examination apparatus 120 according to this embodiment having such a structure, in the same way as in the examination apparatus 101 according to the ninth embodiment, it is possible to acquire detailed low-blur images of the specimen A while moving, regardless of the dynamic behavior of the specimen A. In addition, unlike the ninth embodiment in which the focal position C is adjusted at the measurement head 106 side, the stage 124 is moved upwards and downwards so as to cancel out the dynamic behavior at the focal position C according to the dynamic behavior of the specimen A, and therefore, an advantage is afforded in that the objective optical system 119, which does not tolerate vibrations, can remain fixed in place

### Eleventh Embodiment

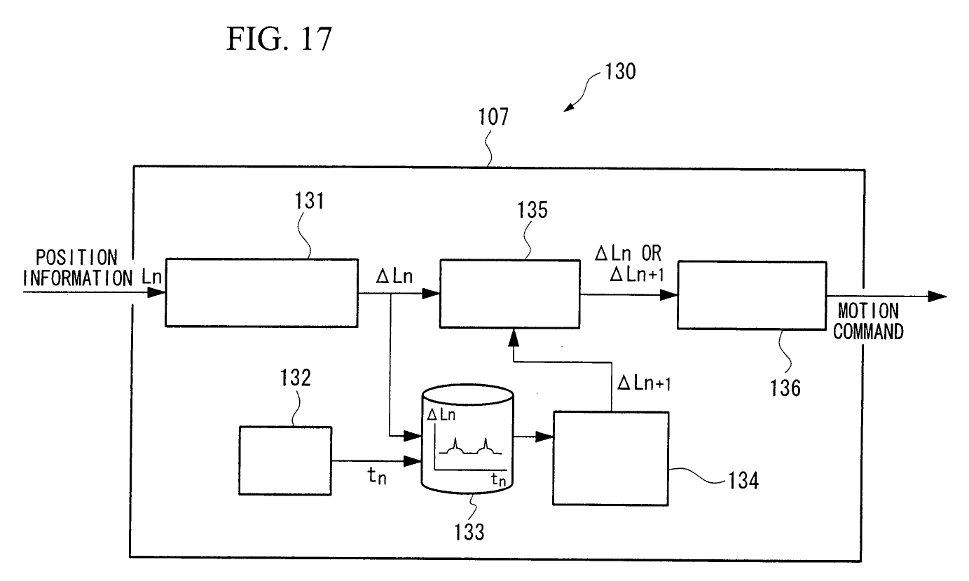

Next, an examination apparatus 130 according to an eleventh embodiment of the present invention will be described below with reference to FIG. 17.

The examination apparatus 130 according to this embodiment differs from the examination apparatuses 101 and 120 according to the above-described ninth and tenth embodiments in terms of the control device 107.

As shown in FIG. 17, the control device 107 of the examination apparatus 130 according to this embodiment includes a change-of-distance calculating unit 131 that successively receives position information from the distance sensor 116 and calculates a change-of-distance ΔLn of the surface of the specimen A with respect to a predetermined reference distance L; a history recording unit 133 that receives the change-of-distance ΔLn calculated in the change-of-distance calculating unit 131 and time information tn generated by a clock 132 and that stores them in association with each other to record a history of the dynamic behavior of the specimen A; a change-of-distance estimating unit 134 that calculates an estimation value ΔLn+1 of the change-of-distance in the subsequent step based on the history stored in the history storing unit 133; a switching unit 135 that selects either the actual change-of-distance ΔLn or the estimation value ΔLn+1 of the change-of-distance; and a motion-command calculating unit 135 that calculates a motion command for the focal position based on either the change-of-distance ΔLn or the change-of-distance estimation value ΔLn+1.

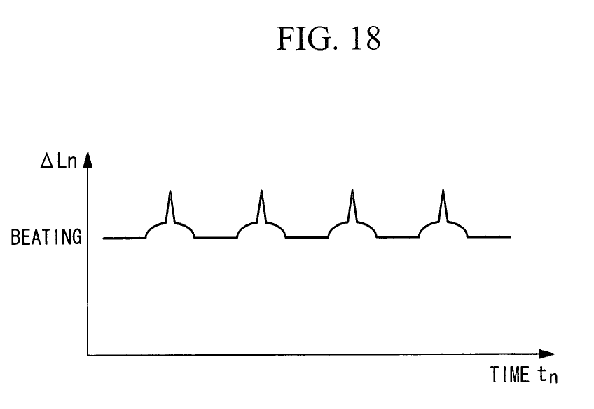

With the examination apparatus 130 according to this embodiment having such a structure, when the position information from the distance sensor 116 is input to the control device 107, the change-of-distance ΔLn of the surface of the specimen A is calculated in the change-of-distance calculating unit 131 based on the position information. Until the history of the dynamic behavior of the specimen A is created, the change-of-distance ΔLn calculated in the change-of-distance calculating unit 131 serves as a basis for the calculation of the focus-position motion commands to the focus adjusting unit, such as the linear actuator 117, and motion commands calculated based on ΔLn from the focus-position motion-command calculating unit 136 are output. In this case, the change-of-distance ΔLn calculated in the change-of-distance calculating unit 131 is input to the history storage unit 133 together with the time tn at which the change-of-distance ΔLn occurred, and is stored as a history of the dynamic behavior, like that shown in FIG. 18.

For example, dynamic behavior occurring at substantially fixed cycles, such as a heart beat, does not vary rapidly, and the next behavior can thus be predicted by taking into account a certain amount of the history. In the change-of-distance estimating unit 134, the next change-of-distance estimation value ΔLn+1 is calculated based on the history recorded in the history recording unit 133 and is then output. The estimation may be carried out, for example, based on the average change-of-distance of a plurality of previous periods, on frequency fluctuations, and so on.

Then, after a certain time has passed, by operating the switching unit 135 as required to select the change-of-distance estimation value ΔLn+1, the change-of-distance estimation value ΔLn+1 is set as a basis for calculation of the motion commands to the focus adjusting unit. That is to say, with the examination apparatus 130 according to this embodiment, the dynamic behavior is estimated in advance based on the history of dynamic behavior of the specimen A. Therefore, a shift in adjusting the focal position according to the actual dynamic behavior can be prevented, and it is possible to make the focal position track the dynamic behavior of the specimen A with better accuracy.

1. An examination apparatus comprising:
an imaging unit that images a specimen exhibiting dynamic behavior;
a behavior detecting unit that detects the dynamic behavior of the specimen;
an image storing unit that stores the dynamic behavior of the specimen detected by the behavior detecting unit and images of the specimen imaged by the imaging unit so as to be associated with each other; and
a still-image extraction unit that extracts an image of the specimen when the specimen is substantially still based on the dynamic behavior of the specimen from the images of the specimen stored in the image storing unit.

2. An examination apparatus according to claim 1 wherein the behavior detection unit is an electrocardiograph.

3. An examination apparatus according to claim 1, further comprising a scanner that scans light on the specimen, wherein, the scanner is configured so as to be controlled based on the dynamic behavior of the specimen.

4. An examination apparatus comprising:
an imaging unit that images an examination site of a specimen exhibiting dynamic behavior;
an imaging optical system disposed between the imaging unit and the examination site;
a focus adjusting unit that adjusts the focal position of the imaging optical system;
a behavior detecting unit that detects the dynamic behavior of the specimen; and
a control device that controls the focus adjusting unit so as to make the focal position coincident with the examination site, based on the dynamic behavior of the specimen detected by the behavior detecting unit.

5. An examination apparatus according to claim 4, wherein the behavior detecting unit is a sensor that detects the surface position of the specimen.

6. An examination apparatus according to claim 4, wherein the focus adjusting unit includes a variable-focus lens whose focal length is varied based on a control signal from the control device.

7. An examination apparatus according to claim 4 wherein the focus adjusting unit is formed of a linear actuator that moves the focal position of the imaging optical system based on a control signal from the control device.

8. An examination apparatus according to claim 4, further comprising:
a stage on which the specimen is mounted;
wherein the focus adjusting unit is formed of a linear actuator that displaces the stage based on a control signal from the control device.

9. An examination apparatus according to claim 5, wherein the control device controls the focus adjusting unit so as to maintain the focal point of the imaging optical system at a position in the depth direction shifted by a predetermined distance from the surface position of the specimen detected by the sensor.

10. An examination apparatus according to claim 4, wherein the control device includes a history recording unit that records the history of the dynamic behavior of the specimen detected by the behavior detecting unit and a behavior estimating unit that estimates the dynamic behavior of the specimen based on the history recorded in the history recording unit, and the control device controls the focus adjusting unit based on the estimated dynamic behavior.
